(19) United States
(12) Patent Application Publication
(10) Pub. No.: US 2026/0235450 A1
(43) Pub. Date: Aug. 13, 2026

(54) NON-REVERSIBLY ACTIVATABLE TEMPERATURE EXTREMUM INDICATION DEVICE

(71) Applicant: BEAUCARNEA, LARMOR-PLAGE (FR)

(72) Inventor: Tegwen NAVEOS, GUIDEL (FR)

(21) Appl. No.: 19/156,096

(22) PCT Filed: Feb. 21, 2024
(86) PCT No.: PCT/EP2024/054349

§ 371 Date: Aug. 13, 2025

(30) Foreign Application Priority Data
Feb. 23, 2023 (FR) FR2301681

(51) Int. Cl. G01K 5/70

(52) U.S. Cl. CPC G01K 5/70

(57) ABSTRACT

The invention relates to a temperature extremum indication device (1) comprising: —a bimetallic metal strip (3), —an indicator (5) configured to be rotated by the bimetallic metal strip (3), and —a needle (7, 9), the device (1) being arranged to non-reversibly move: —from a neutral configuration in which the needle (7, 9) remains stationary when the indicator is in motion, into —a loaded configuration in which the needle (7, 9) is rotated by the indicator (5).

### FIELD OF THE INVENTION

The invention relates to temperature extremum indicators, particularly for monitoring the temperature extremes to which an object, and in particular a bottle of wine, has been exposed.

### STATE OF THE ART

It is known that some objects, in particular medical or biological products, high-tech products or foodstuffs, must be stored within specific temperature ranges so as not to be altered.

Among these objects is wine which is a product particularly sensitive to temperature and to its variations. Its quality and its tasting experience can change dramatically depending on whether it has been exposed to a too high or too low temperature for a longer or shorter time. Wine does not tolerate rapid and frequent thermal amplitudes or extreme temperatures (frost, sun exposure). An excessively high temperature can accelerate the aging of a wine, but in some cases, causes a premature degradation of its natural qualities; it will not reach the potential of regular aging at a normal and stable temperature. While wine is most often placed in favorable thermal conditions during vinification, the marketing phase seems to put wine bottles at greater risk. Indeed, wine follows a distribution chain passing into the hands of merchants, wholesalers, and other distributors, during which it may be exposed to unsuitable temperatures for highly variable durations and in a rarely controlled manner.

For these objects, whose good quality depends on the storage temperatures, there is a need for a temperature extremum gauge to which the object is exposed, and particularly gauges that can be activated before a critical period of transport or distribution.

### DISCLOSURE OF THE INVENTION

One aim of the invention is to propose a temperature extremum gauge that can be activated before a critical transport or distribution period.

This aim is achieved within the framework of the present invention thanks to a device for indicating the temperature extremum comprising:
a bimetal strip,
a gauge configured to be driven in rotation by the bimetal strip, and
a needle,
   the device being arranged to non-reversibly switch:
from a neutral configuration where the needle remains stationary when the gauge is in motion,
to an armed configuration where the needle is driven in rotation by the gauge.

Such a device is advantageously and optionally supplemented by the following different characteristics taken alone or in combination:
the device comprises:
   a dial, the needle being movably mounted on the dial in rotation around an axis (A), and
   a support for the bimetal strip, the support comprising hooks, so that when the device switches from the neutral configuration to the armed configuration, the support moves along the axis (A) towards the dial and the hooks deform elastically to attach to the dial;
the dial comprises a disk extending all around the axis (A) and comprising an upper face and a lower face, the lower face facing the bimetal strip, the disk having a slot which extends in a circumferential direction around the axis, the slot passing through the dial from the upper face to the lower face along an axial direction parallel to the axis (A), the needle passing through the dial in the axial direction and protruding from the dial from the lower face so as to form a stopper, the stopper being located along the axial direction between the dial and the bimetal strip,
the device being configured:
   so that, in the neutral configuration, the stopper and the gauge are separated along the axial direction so that the stopper is located along the axial direction between the lower face and the gauge, and
   to switch from the neutral configuration to the armed configuration by displacement of the support, of the bimetal strip and of the gauge towards the dial along the axial direction so that along the axial direction, a distance separating the lower face and the gauge is smaller than or equal to a distance separating the lower face and the stopper;
the needle is movably mounted on the dial in a single way of rotation around an axis (A), advantageously the needle comprises a pawl, the slot and the pawl being in contact according to asymmetrical toothed shapes;
the dial has a groove passing through the dial from the upper face to the lower face along the axial direction, the groove extending in a circumferential direction around the axis (A), so that the gauge is facing the groove along the axial direction, the groove and the slot extending around the axis (A) in angular sectors around the axis which do not overlap;
the upper face comprises a first set of temperature graduations and a second set of temperature graduations, each set extending circumferentially around the axis (A) along the slot, the first set being located between the axis (A) and the slot, the slot being located between the first set and the second set, the needle comprising:
   a circumferential portion which extends circumferentially facing the slot, the circumferential portion comprising a first tip in the direction of the first set and a second tip in the direction of the second set, the first tip and the second tip defining the same radial direction relative to the axis (A),
   an internal portion which extends facing the first set of graduations and forms a first loop,
   an external portion which extends facing the second set of graduations and forms a second loop,
      the upper face and the needle being configured so that when the radial direction passes through one of the graduations, then one of the graduations is surrounded by the first loop or the second loop;
the needle is a first needle, the device comprising a second needle, the first needle and the second needle being configured to be driven by the gauge in different ways of rotation;
the slot is a first slot, the dial having a second slot which extends in a circumferential direction around the axis, the groove, the first slot and the second slot being evenly distributed angularly around the axis (A), the second needle advantageously comprising a second pawl, the second slot and the second pawl being in contact according to asymmetrical toothed shapes;
a case defining a housing closed by the dial, the bimetal strip and the gauge being located in the housing, the case comprising a lower wall, the bimetal strip being located axially between the dial and the lower wall, the lower wall defining an orifice opening out into the housing and outside the case, the support comprising a pusher which extends through the lower wall through the orifice along the axis (A), the pusher and the orifice having shapes complementary in section to the axial direction, the complementary shapes not having symmetry of revolution relative to the axis (A);
the lower wall has a central recess directed towards the bimetal strip so that, in the neutral configuration, one end of the pusher farthest from the bimetal strip is located along the central axis (A) closer to the bimetal strip than one end of the lower wall farthest from the bimetal strip;
one of the case and of the dial comprises a notching extending in a circumferential direction to the axis (A) and the other of the case and of the dial comprises a tooth configured to collaborate with the notching so as to fix an angular position between the case and the dial; and
the device comprises a part made of transparent material facing the dial, the dial being enclosed between the case and the transparent material part.

The invention also relates to a method for indicating a temperature extremum comprising the non-reversible switching:
from a neutral configuration where a needle remains stationary when a gauge is driven in rotation by a bimetal strip,
to an armed configuration where the needle is driven in rotation by the gauge.

Such a method is advantageously and optionally supplemented by the following different characteristics taken alone or in combination:
the needle is mounted on a dial so that the needle is movable relative to the dial around an axis (A), the switching from the neutral configuration to the armed configuration comprising the displacement along the axis of a support of the bimetal strip towards the dial and the attachment of hooks of the support to the dial by elastic deformation of the hooks; and
the displacement of the support is configured so that a distance along an axial direction parallel to the axis (A) between the gauge and a lower face of the dial, the lower face facing the bimetal strip, becomes smaller than or equal to a distance along the axial direction between a stopper of the needle and the lower face, the stopper being located between the dial and the bimetal strip.

### DESCRIPTION OF THE FIGURES

Other characteristics and advantages of the invention will emerge from the following description, which is purely illustrative and non-limiting, and which should be read in relation to the appended drawings in which:

FIGS. 1 to 7 are schematic representations of a device according to one embodiment of the invention.

### DETAILED DESCRIPTION OF THE INVENTION

### Bimetal Strip

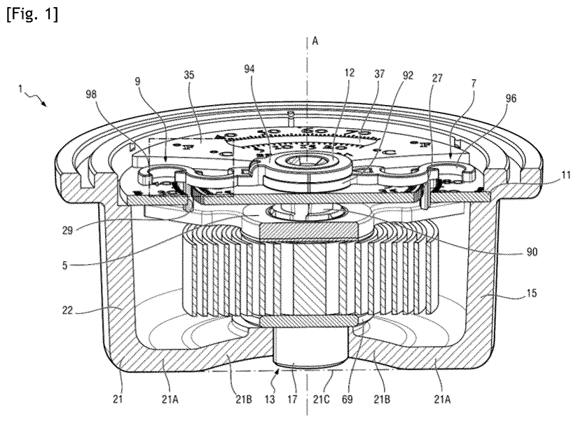

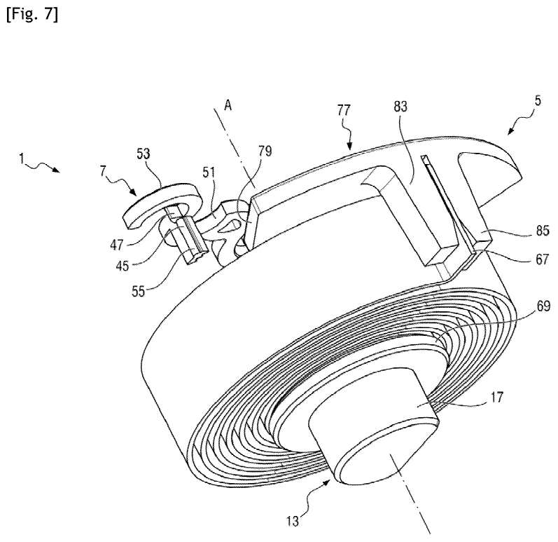

In relation to FIGS. 1 to 7, a device 1 for indicating a temperature extremum comprises a bimetal strip 3. The bimetal strip 3 comprises a slip formed from two sheets of two different metals fixed to each other. The thickness of the slip is comprised between 5 and 9 millimeters, preferably between 6 and 8 millimeters. Ideally, a thickness of 7.2 millimeters is chosen for the slip. The bimetal strip 3 is wound around a central axis A of the device 1 according to a spiral shape. The total diameter of the bimetal strip 3 can be:
greater than or equal to 21 millimeters, and preferably greater than or equal to 25 millimeters,
less than or equal to 31 millimeters, and preferably less than or equal to 27 millimeters.

Ideally, a total diameter equal to 26 millimeters is chosen for the bimetal strip 3. The bimetal strip 3 may comprise between 6 and 12 turns, and preferably between 7 and 11 turns. Ideally, the bimetal strip 3 comprises 9 turns.

The bimetal strip 3 comprises an internal end 65 and an external end 67. Each of the ends 65 and 67 comprises a straight portion in which the slip extends on the one hand along an axial direction parallel to the axis A and on the other hand along a radial direction. A radial direction is a direction perpendicular to the axis A and which passes through this axis A.

The straight portion of the internal end 65 has a length along a radial direction comprised between 4 and 6 millimeters, the length ideally being 4.8 millimeters.

The straight portion of the external end 67 has a length along a radial direction comprised between 1 and 3 millimeters, the length ideally being 1.8 millimeter.

The axis A passes through the internal end 65. It is possible to define, from the straight portions of the ends 65 and 67, an angle centered on the straight central axis in a radial plane. Here, a radial plane is defined as a plane perpendicular to the axis A. The bimetal strip 3 is configured to be heat-sensitive so that the angle changes as a function of temperature. Particularly, an angle variation can be chosen as a function of the temperature variation:
greater than or equal to 2 angle degrees per degree Celsius, and preferably greater than or equal to 2.5 angle degrees per degree Celsius;
less than or equal to 3.6 angle degrees per degree Celsius, and preferably less than or equal to 3.1 angle degrees per degree Celsius.

Ideally, an angle variation is chosen as a function of the temperature variation equal to 2.8 angle degrees per degree Celsius, namely 56 angle degrees for a variation of 20 degrees Celsius.

During the manufacture of the bimetal strip, it can be imposed that the angle separating the straight portions of the ends 65 and 67 is equal to zero for a temperature of 20° C., i.e., the straight portions are in the continuation of each other at this temperature.

The way of rotation around the central axis A of the external end 67 relative to the internal end 65 is defined as:
positive when the temperature increases, and
negative when the temperature decreases.

### Current Temperature Gauge

The device 1 comprises a gauge 5 configured to be driven in rotation by the bimetal strip 3. This gauge 5 can in particular act as a current temperature display. By current temperature, it is meant the current temperature of the bimetal strip or the temperature of the bimetal strip at the time when the angular deviation of the bimetal strip is measured. In relation to FIG. 6, the gauge 5 comprises a central portion 75 which extends annularly around the central axis A. This central portion 75 has the shape of a hollow annulus in its center so as to leave free of material an area passing through the central axis A and surrounding the central axis A. The gauge 5 comprises a peripheral portion 77 which extends perpendicularly to the central axis from the central portion 75 while getting farther from the central axis A. The peripheral portion 77 comprises two side walls 79 and 81 which each extend in a radial direction and parallel to the central axis A. The peripheral portion 77 extends between these two side walls over an angular sector centered on the central axis A which is approximately 56 angle degrees. The value of the angular sector can thus be comprised between 53 and 60 angle degrees and preferably between 55 and 57 angle degrees.

The gauge 5 extends along the axial direction between a lower wall facing the bimetal strip and an upper wall. The thickness of the gauge in this axial direction can be chosen between 1 and 2 millimeters, for example equal to 1.6 millimeter. The lower and upper walls are orthogonal to the central axis A. The upper wall comprises a temperature mark 39 identifiable by an operator.

Two barrier plates 83 and 85 extend from the lower wall of the gauge 5 along the axial direction. The two barrier plates 83 and 85 are located on either side of the straight portion of the external end 67, and are in contact or almost in contact with this straight portion. The barrier plates 83 and 85 extend in the radial direction associated with this straight portion over a length of approximately 5 millimeters. The gauge 5 is movably mounted in rotation around the central axis relative to the internal end 65 of the bimetal strip. The motion of the external end 67 due to a temperature variation causes the rotation of the gauge 5 around the central axis via the barrier plates 83 and 85.

Thus the gauge 5 rotates relative to the internal end 65:
in the positive way when the temperature increases, and
in the negative way when the temperature decreases.

Optionally, the upper end 67 comprises, in the continuation of the straight portion radially outwards, a bend in which the slip extends on the one hand along an axial direction parallel to the axis A and on the other hand along a circumferential direction. A circumferential direction is orthogonal to the axis A and orthogonal to the radial direction. According to this option, the two barrier plates 83 and 85 are located on either side of the straight portion and of the bend of the external end 67. Each barrier plate 83 and 85 comprises on the one hand a straight portion which extends in the radial direction associated with the straight portion of the external end 67, and on the other hand a bent portion which extends in the circumferential direction associated with the bend of the external end 67, the bent portion extending in the continuation of the straight portion. The bend of the upper end 67 is surrounded radially outwardly by a first bent portion and radially inwardly by a second bent portion. The addition of the bend and of the bent portions allows for better holding of the gauge 5 on the external end of the bimetal strip, so that these two parts are better held together, in particular during transport or handling of the device.

### Support of the Bimetal Strip

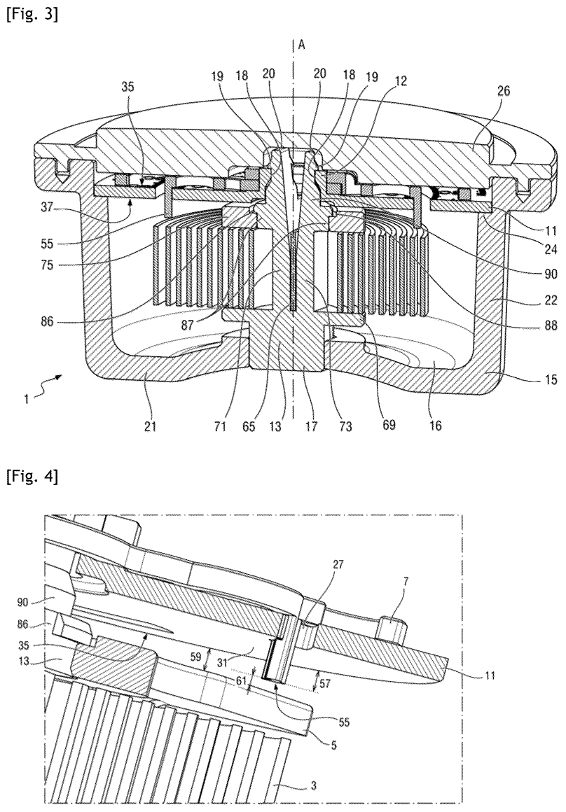

The device 1 may comprise a support 13 for the bimetal strip 3. Such a support 13 extends along the central axis A through the bimetal strip 3. In relation to FIG. 3, the support 13 may comprise a platform 69 configured to be in contact along a radial plane with the first turns of the bimetal strip, i.e. the first turns that surround the internal end 65 of the bimetal strip. This platform 69 is configured to support these first turns. The support 13 comprises two rods 71 and 73 which extend from the platform 69 in the axial direction, i.e. in the direction of the central axis A. The two rods are facing each other and define together an interstice into which the straight portion of the internal end 65 of the bimetal strip 3 can be inserted. The platform 69 is not split at the level of the axis so that the platform 69 is configured to block the straight portion of the internal end 65 of the bimetal strip 3 thus inserted in the interstice in a way of the central axis A. The two rods extend parallel to the radial direction associated with the straight portion so that the straight portion of the internal end 65 cannot rotate around the central axis A relative to the support 13.

### Spouts of the Support of the Bimetal Strip

Each of the two rods 71 and 73 extends along the axial direction from the platform 69 to a distal end 20. The two rods 71 and 73 extend from the platform along the axial direction and, in a reference position of the support, get farther from each other. The reference position corresponds to a position where the support is not subjected to a particular mechanical stress. The rods 71 and 73 are chosen to be sufficiently thin and they are made of a sufficiently elastic material so that an operator can, by manual pressure, bring the rods 71 and 73 closer to each other, and in particular the distal ends 20 closer to each other. This deformation brings the support into a stressed position. This deformation is elastic so that when the operator stops exerting a pressure on the support 13, the rods 71 and 73 and the distal ends 20 leave the stressed position and return to the reference position.

The rods 71 and 73 have an accommodation area 87 configured to receive the central portion 75 of the gauge 5. The rods 71 and 73 define, in the reference position, a diameter in a radial plane at the level of the accommodation area 87 slightly smaller than the internal diameter of the annulus of the central portion 75 of the gauge 5. The rods 71 and 73 each have a spout 86 and 88 which protrudes radially outwardly relative to the central axis. The spouts 86 and 88 are located in the same axial position so that the accommodation area 87 is located between the platform 69 and the spouts 86 and 88. The spouts 86 and 88 define, in the reference position, an external diameter in a radial plane which is slightly greater than the internal diameter of the annulus of the central portion 75 of the gauge 5.

Between the spouts 86 and 88 and the distal ends 20, the rods 71 and 73 have a radially external diameter smaller than the internal diameter of the annulus of the central portion 75 of the gauge 5.

It is possible to insert the distal ends 20 of the rods through the annulus of the central portion 75 of the gauge 5 and to slide the central portion 75 until it comes into contact with the spouts. Then, an operator can exert a slight force so that the central portion 75 is pressed against the spouts 86 and 88 in the direction of the platform 69. The rods 71 and 73 of the gauge get closer to each other under the action of this force, and the support takes the stressed position. Since the central portion 75 is then no longer blocked by the spouts 86 and 88, it can be brought closer to the platform 69 as far as the accommodation area 87. The spouts are in contact with the internal wall of the annulus which keeps the rods 71 and 73 in a close position. When the central portion 75 is located below the spouts, the spouts 86 and 88 are no longer in contact with the internal wall of the annulus and the support 13, the rods 71 and 73 and the distal ends 20 leave the stressed position and return to the reference position. The annulus of the central portion 75 is then retained by the spouts between the platform 69 and the spouts. Particularly, the gauge 5 can be placed in this area when the bimetal strip 3 is placed in contact against the platform 69. In this manner, the bimetal strip 3 and the gauge 5 are axially retained by the platform 69 on the one hand and by the spouts on the other hand: the bimetal strip is axially blocked by the platform 69, the bimetal strip and the gauge 5 are axially blocked together and the gauge 5 is axially blocked by the spouts. In addition, the distance separating the platform 69 and the spouts 86 and 88 can be adjusted to the length along the central axis A of the bimetal strip and the central portion 75 of the gauge 5. In this manner, the lower wall of the gauge is in contact or almost in contact with turns of the bimetal strip. The distance adjustment leaves sufficient mechanical clearance for the turns of the bimetal strip and the gauge 5 to be able to rotate around the axis relative to the support 13.

### Hook of the Support of the Bimetal Strip

The two rods 71 and 73 may comprise hooks 19 between the spouts 86, 88 and the distal ends 20. The hooks 19 radially protrude outwardly relative to the central axis. These hooks 19 are in the immediate vicinity of a hollow 18 of the two rods 71 and 73 so that, axially from the spouts towards the distal ends 20, the external diameter of the support decreases at the level of the hollow 18 and increases at the level of the hooks 19 before decreasing again at the level of the distal ends 20. The rods 71 and 73 may also have a bearing 90 located axially between the spouts 86, 88 and the hollow 18. The bearing 90 of the rods 71 and 73 defines an outer diameter which is greater than the outer diameter of the hollow 18.

### Needle of Minimum or Maximum Temperature Reached

The device 1 also comprises a needle 7 or 9. Optionally, the device comprises two needles 7 and 9.

The two needles have many similar characteristics which will now be presented. The needle 7 (respectively 9) comprises a central ring 92 (respectively 94) that surrounds the central axis A. The central ring 92 (respectively 94) leaves an area passing through the central axis A free of any material. This area may take the form of a disk centered on the central axis A, the central ring defining a constant inner diameter centered on the central axis A. The central ring 92 (respectively 94) may also define a constant outer diameter centered on the central axis A.

The needle 7 (respectively 9) comprises a body 96 (respectively 98) which extends radially from the central ring 92 (respectively 94) while getting farther from the central axis A. The central ring 92 (respectively 94) and the body 96 (respectively 98) are rigidly connected to each other.

The body 96 (respectively 98) may comprise in particular a circumferential portion 45 which extends circumferentially around the central axis A. The circumferential portion 45 comprises a first tip 47 which extends radially from the circumferential portion 45 outwards i.e. while getting farther from the central axis A—and points in a radial direction passing through the central axis A. The circumferential portion 45 comprises a second tip 49 which extends radially from the circumferential portion 45 inwards—i.e. while getting closer to the central axis A—and points in the same radial direction as the first tip 47. The body 96 (respectively 98) may comprise an internal portion 51 which extends radially from the central ring 92 (respectively 94) outwards and as far as the circumferential portion 45.

The body 96 (respectively 98) may comprise an external portion 53 which extends radially from the circumferential portion 45 outwards.

In a radial plane, the internal portion 51 may form a first loop and the external portion 53 may form a second loop, each of the loops being in a continuation of the circumferential portion 45. The body 96 (respectively 98) thus takes the shape of an S whose center is the circumferential portion 45.

When the device 1 comprises the two needles 7 and 9, the bodies 96 and 98 extend in angular sectors centered on the central axis A which are different. In particular, these angular sectors where the bodies 96 and 98 extend may be centered on radial directions that form together an angle greater than or equal to 120 degrees. The bodies 96 and 98 may be located at the same axial position along the central axis A. The central rings 92 and 94 may be located at different axial positions along the central axis A. Each ring 92 and 94 and each body 96 and 98 has the same axial thickness along the central axis A which is between 0.5 millimeter and 2 millimeters, ideally 1 millimeter. One of the central rings, for example the ring 92, may have the same axial position as the bodies 96 and 98, the other of the rings, for example the ring 94, being offset along the central axis A relative to this axial position. The offset is typically equal to the axial thickness mentioned above. The rings 92 and 94 may be in contact or almost in contact with each other. Each body 96 and 98 takes the shape of an S whose center is the circumferential portion 45, the Ss being able to be oriented in identical or opposite ways. The orientation of the S may in particular be assessed by traversing the body of the needle radially from the inside to the outside by the angle of a tangent to the body relative to a mean radial direction of the body. Preferably, the Ss of the bodies 96 and 98 are oriented in opposite ways.

The body 96 (respectively 98) of the needle 7 (respectively 9) comprises a stopper 55 which extends axially from the circumferential portion 45. The stopper 55 may extend from the circumferential portion over a length comprised between 2 and 3 millimeters, for example 2.8 millimeters.

The device 1 is arranged so that the gauge 5 is located axially between the bimetal strip 3 and the needle 7 (respectively 9). In projection onto a radial plane, the needle 7 (respectively 9) is placed angularly in the positive (respectively negative) way relative to the gauge 5.

When the device 1 comprises the two needles 7 and 9, the gauge 5 is located axially between on the one hand the bimetal strip 3 and on the other hand the needles 7 and 9. In projection onto a radial plane, the needle 7 is placed angularly in the positive way relative to the gauge 5 and the needle 9 is placed angularly in the negative way relative to the gauge 5. The stopper 55 extends axially from the circumferential portion 45 in the direction of the gauge 5 and of the bimetal strip 3.

In the most general embodiment, the device 1 can be arranged in two different configurations.

In a first configuration, called neutral configuration, the needle 7 (respectively 9) remains stationary when the gauge 5 is in motion. In particular, the gauge 5 does not come into contact with the needle 7 (respectively 9).

In a second configuration, called armed configuration, the needle 7 (respectively 9) is driven by the gauge 5. For example, the gauge 5 can come into contact with the stopper 55 of the needle 7 (respectively 9) and push the needle in a way of rotation. More specifically, it is one of the side walls 79 or 81 of the gauge 5 that comes into contact with the stopper 55.

It should be noted that in both the neutral and armed configurations, the gauge 5 configured to be driven in rotation by the bimetal strip 3 remains free to rotate, i.e. the bimetal strip 3 is also free to rotate around the axis A. It is thus not necessary to keep the bimetal strip 3 fixed to avoid temperature monitoring by the device when it is in the neutral configuration. This allows limiting the wear of the bimetal strip 3 compared to a situation where the internal end 65 and the external end 67 are kept fixed in the neutral configuration so that the deformations due to the temperature variations of the bimetal strip 3 generate inner stresses in the bimetal strip which can accelerate the wear of the bimetal strip.

The switching from the neutral configuration to the armed configuration can be controlled, which allows choosing when temperature monitoring starts. It is thus possible to convey and store the device in neutral configuration, i.e. in a mode where the temperature is not monitored, then to precisely choose the start date of the monitoring of the temperature variations.

The switching from the neutral configuration to the armed configuration can occur by axially bringing the gauge 5 and the bimetal strip 3 closer to each other, in particular by moving the support 13 axially, towards the needle 7 (respectively 9), and in particular the stopper 55 of the needle.

In relation to FIG. 4, the device 1 can be arranged in the neutral configuration so that the stopper 55 and the gauge 5 are separated by a non-zero distance 61 along the axial direction. In the armed configuration, the stopper 55 of the needle 7 (respectively 9) is brought closer to the gauge 5 and to the bimetal strip 3 so that along the axial direction, the gauge 5 is at the same axial level as the stopper 55. The needle 7 (respectively 9) can be driven by the gauge 5 in rotation in the positive (respectively negative) way.

It should be noted that the device 1 is intended, in operation, to cover a temperature range comprised between −15 degrees Celsius and +45 degrees Celsius, namely a dynamic range equal to 60 degrees Celsius. Given the angle variation of the bimetal strip as a function of the temperature variation, a dynamic range equal to 60 degrees Celsius corresponds to less than 180 angle degrees. It is therefore unlikely that the gauge 5 will complete a full turn around the central axis A. This is why it can be said that the needle 7 (respectively 9) is driven in rotation by the gauge 5 in the only positive (respectively negative) way.

The needle 7 is an indicator of the maximum temperature reached by the bimetal strip.

The needle 9 is an indicator of the minimum temperature reached by the bimetal strip.

By arranging a needle 7, 9 on either side of the gauge 5 relative to the circumferential direction, it acts as an indicator of the maximum or minimum temperature reached by the bimetal strip. By arranging a needle on each side of the gauge 5, one needle acts as an indicator of the maximum temperature reached by the bimetal strip and the other needle acts as an indicator of the minimum temperature reached by the bimetal strip. In this case, the first needle 7 and the second needle 9 are configured to be driven by the gauge 5 in different ways of rotation.

It is possible to impose that the device 1 switches from the neutral configuration to the armed configuration in a non-reversible manner.

The irreversible nature of this switching provides the technical effect of not being able to interrupt the temperature monitoring once the device has been armed, i.e. it allows the tamper-evidence of the temperature monitoring.

### Dial

The device 1 may comprise a dial 11. The dial 11 extends all around the central axis A and takes the form of a disk centered on the central axis A. The diameter of the disk is greater than the diameter of the bimetal strip 3. The dial 11 has a central sleeve 12 surrounding the central axis A so as to leave the axis A free of material, and around the central axis A as to leave an area free of material.

In relation to FIGS. 1 and 3, the dial 11 may carry one needle 7, 9 or two needles 7, 9, for example by arranging the central ring 92, 94 of the needle 7, 9 around the central sleeve 12. The needle 7, 9 is movably mounted on the dial 11 in rotation around the central axis A. For example, the outer diameter of the central sleeve 12 and the inner diameter of the central ring 92, 94 of the needle 7, 9 may be adjusted so as to leave enough mechanical clearance to allow the rotation around the central axis A of the needle 7, 9 relative to the central sleeve 12.

The disk of the dial 11 comprises an upper face 35 and a lower face 33, the lower face 33 facing the bimetal strip 3 and the gauge 5. The thickness of the dial along the central axis A between the upper face and the lower face may be chosen to be greater than or equal one millimeter.

The needle 7, 9 is placed on the central sleeve 12 so as to be facing the upper face 35.

The central sleeve 12 therefore rises along the axial direction above the upper face 35 over a height that is greater than or equal to the axial thickness of a central ring. Advantageously, this elevation occurs at least over a height corresponding to two axial thicknesses of a central ring, so that the sleeve 12 accommodates on its exterior the central rings 92 and 94 one above the other.

The central sleeve 12 has an inner wall that defines an inner diameter centered on the central axis A. This inner diameter can vary axially.

From the bottom of the central sleeve 12, i.e., axially on the side of the bimetal strip 3, to the top of the sleeve, i.e., axially on the side of the dial 11, the inner diameter decreases. The central sleeve 12 then has an inner narrowing as it runs from bottom to top.

The low area of the central sleeve 12 has an inner diameter greater than or equal to the outer diameter of the hooks 19 when the support 13 is in the reference position.

The high area of the central sleeve 12 has an inner diameter which, when the support 13 is in the reference position, is:
greater than the outer diameter of the hollow 18 of the rods 71 and 73, and
less than the outer diameter of the hooks 19,
greater than or equal to the outer diameter of the rods between the hooks 19 and the distal ends 20 of the rods 71, 73.

Between the low area and the high area of the sleeve 12, the sleeve 12 has a transition area where the inner diameter decreases progressively. This decrease can advantageously correspond to the decrease of the outer diameter of the rods 71, 73 between the hooks 19 and the distal ends 20 of the rods 71, 73.

In the neutral configuration, the dial 11 is not placed in the hollow 18 of the rods 71 and 73 of the support 13. The dial 11 can be kept in contact with the hooks 19, and more specifically the hooks 19 can come into abutment in the central sleeve 12 at the level of the transition area. The transition area of the central sleeve 12 thus blocks the rods at the level of the hooks 19. The rods are held in the central sleeve 12 of the dial 11. Particularly, the distal ends 20 of the rods 71 and 73 can extend into the high portion of the sleeve, beyond the transition area. The distal ends 20 of the rods 71 and 73 may abut with the upper end of the central sleeve 12 opposite to the bimetal strip 3.

The armed configuration may in particular correspond to the situation where the dial 11 is placed in the hollow 18 of the rods 71 and 73 of the support 13. The dial 11 is then held between the hooks 19 and the bearing 90 of the rods 71 and 73.

The switching from the neutral configuration to the armed configuration may in particular occur by moving the support 13 along the central axis A towards the dial 11. The bimetal strip 3 and the gauge 5 are carried by the support 13 towards the dial 11. It is possible to slide the distal ends 20 of the rods 71, 73 through the central sleeve 12 of the dial 11 until this central sleeve 12 comes into contact with the hooks 19. In particular, the hooks 19 may be in abutment in the central sleeve 12 at the level of the transition area. Then, an operator can exert a slight force so that the transition area of the central sleeve 12 is pressed against the hooks 19 in the direction of the platform 69 or equivalently to pressing the hooks 19 against the transition area of the central sleeve 12 in the direction opposite to the bimetal strip 3. The rods 71 and 73 of the gauge get closer to each other under the action of this force, and the support 13 takes the stressed position. Since the central sleeve 12 is then no longer blocked by the hooks 19, it gets closer to the platform 69 as far as the area of the hollow 18 of the rods 71 and 73. The hooks 19 are in contact with the internal wall of the central sleeve of the dial which holds the support 13 and the rods 71 and 73 in the stressed position. The hooks 19 end up coming out of the central sleeve 12. They are then no longer in contact with the internal wall of the central sleeve 12 of the dial 11. The support 13 and the rods 71 and 73 return to the reference position. The hooks 19 deploy radially outwards and form axial abutments for the central sleeve 12. The central sleeve 12 of the dial 11 is then retained by the hooks 19 between the platform 69 and the hooks 19. When the rods 71 and 73 have the bearing 90 located axially between the spouts 86, 88 and the hollow 18, the latter can define an outer diameter which is greater than the inner diameter of a lower portion of the central sleeve 12 of the dial 11. The bearing 90 of the rods blocks the central sleeve 12 in axial translation towards the platform 69. The central sleeve 12 of the dial 11 is then blocked on the one hand towards the platform 69 by the bearing 90 of the rods and on the other hand in the other way by the hooks 19.

During this motion, the support 13 deforms elastically, and particularly the hooks 19 and the rods 71, 73 deform elastically from the reference position, to the stressed position and then back to the reference position. During this motion, the hooks 19 pass through the central sleeve 12 and are attached to the dial 11.

It is the deformation of the hooks 19 that allows giving the non-reversible nature to the switching from the neutral configuration to the armed configuration. It should be noted that other implementations of this non-reversible nature can be carried out. The dial 11 may for example have an elastically deformable portion, in particular at the level of the central sleeve 12.

### Stopper and Driving of the Needle

The stopper 55 of the needle 7, 9 extends through the dial 11, for example through a through-slot 27, 29 of the dial, towards the bimetal strip 3 and the gauge 5. The slot 27, 29 can pass through the dial 11 from the upper face 35 to the lower face 33 along an axial direction parallel to the central axis A. The stopper 55 extends axially towards the bimetal strip 3 beyond the lower face 33 of the dial 11. The stopper 55 extends from the lower face 33 towards the bimetal strip over a length comprised between 1 and 2 millimeters, for example 1.7 millimeter. It is thus possible to define a distance 57 separating the lower face 33 and the stopper 55. The distance 57, as illustrated in FIG. 4, can be more specifically defined between the lower face 33 and the end of the stopper 55 farthest axially from the lower face 33. This distance is comprised between 1 and 2 millimeters, for example 1.7 millimeter.

In the neutral configuration of the device 1, the gauge 5 and the lower face 33 of the dial 11 can be separated by a distance 59 greater than the distance 57. As illustrated in FIG. 4, the distance 59 can be more specifically defined between the lower face 33 and the upper wall of the gauge 5 facing the dial 11. The stopper 55 and the gauge 5 are separated by a distance 61 along the axial direction so that the stopper 55 is located along the axial direction between the lower face 33 and the gauge 5. This distance 61 can be chosen to be comprised between 0.5 millimeter and 1 millimeter, for example 0.6 millimeter. This neutral configuration also corresponds to FIG. 1. In this neutral configuration, the gauge 5 and the stopper 55 extend axially over areas that do not overlap. Also, the gauge 5, whatever its rotational motion, does not come into contact with the stopper 55, cannot push it and thus set the needle 7 in motion.

In the armed configuration, and in relation to FIG. 3, the distance 63 separating the lower face 33 of the dial 11 and the gauge 5 is less than or equal to the distance 57 separating the lower face and the stopper. In this case, the gauge 5 and the stopper 55 extend axially over areas that have a non-zero overlapping. Also, the gauge 5 can, through a rotation, come into contact with the stopper 55, push it and thus set the needle 7 in motion.

The axial displacement of the support 13, of the bimetal strip and of the gauge 5 between the neutral configuration and the armed configuration is therefore greater than or equal to the length 61 that axially separates the stopper 55 and the gauge 5 in the neutral configuration. This axial displacement corresponds to the axial displacement of the hooks 19 during the switching from the neutral configuration to the armed configuration. This axial displacement can be chosen to be equal to 2 millimeters, for example equal to 2.1 millimeters.

### Pawl System

The needle 7, 9 is movably mounted on the dial 11 around the central axis A. More specifically, the needle 7, 9 can be movably mounted in rotation around the central axis A relative to the central sleeve 12.

The needle 7, 9 is set in rotational motion by the gauge 5 when the device 1 is in the armed configuration. This setting in rotation only takes place in one way of rotation, the gauge 5 being able to push the needle in only one way.

The needle 7, 9 has the stopper 55 which passes through the dial 11 by a slot 27, 29. This slot 27, 29 extends in a circumferential direction around the axis so as to allow the rotational displacement of the stopper 55 around the central axis A in the dial 11.

The needle 7, 9 can also be movably mounted on the dial 11 in a single way of rotation around an axis along the axial direction. There are various possibilities for blocking a way of rotation of the needle 7, 9.

For example, the slot 27, 29 of the dial 11 has asymmetrical toothed shapes configured to be in contact with a pawl 31 carried by the needle 7, 9 at the level of the stopper 55. With reference to FIG. 4, the system formed by these toothed shapes and the pawl allows forbidding a way of rotation to the needle 7, 9. The needle 7, 9 is then configured to rotate in only one way of rotation. The pawl 31 may for example comprise three identical teeth protruding towards the central axis A, and the slot 27, 29 may for example have a large number of toothed notches complementary to the teeth of the pawl 31.

This pawl system gives a non-reversible nature to the motion of the needle: once it has been pushed in one way and has been moved at least one additional step in the slot, the needle cannot be moved in the opposite way unless it is dismounted from and remounted on the dial.

### Current Temperature Indication

The dial 11 has a groove 37 which passes right through the dial 11 from the upper face 35 to the lower face 33 along the axial direction parallel to the central axis A. The groove 37 thus allows a view through the dial 11. The device 1 is configured so that the gauge 5 is facing the groove 37 along the axial direction.

An operator located above the dial 11, i.e. facing the upper face 35 of the dial 11, can see the gauge 5 through the groove 37. He can see the upper wall of the gauge 5. This comprises the temperature mark 39 that the operator can identify.

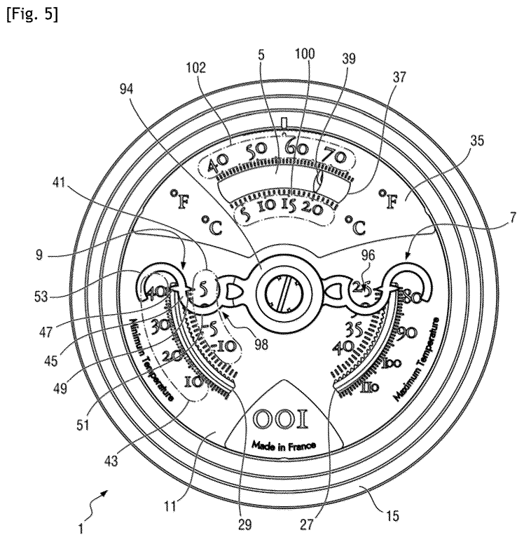

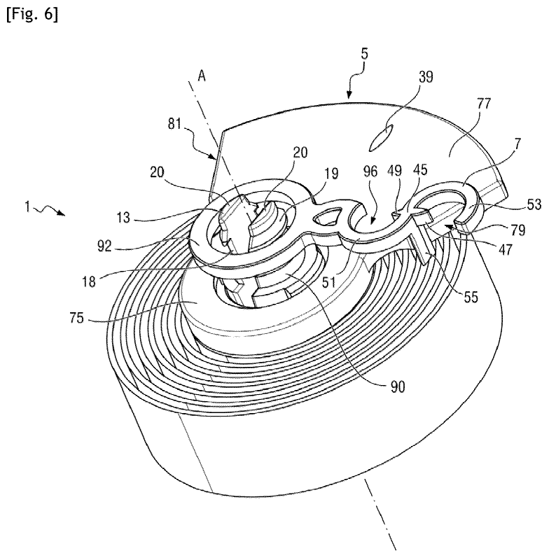

In relation to FIGS. 1 and 5, the groove 37 extends in a circumferential direction around the central axis A. The groove 37 and the slot 27, 29 extend around the central axis A in angular sectors around the axis A that do not overlap.

The groove 37 may extend in this circumferential direction over an angle centered on the axis A that corresponds to the angular variation of the bimetal strip during a temperature variation of approximately 20 degrees Celsius. The range may advantageously be comprised between 20 degrees and 25 degrees. If an angle variation is chosen as a function of the temperature variation equal to 2.8 angle degrees per degree Celsius, this gives approximately 56 angle degrees for the extent of the groove 37 in the circumferential direction. This corresponds in particular to the case where the device 1 is intended, in operation, to be fixed on a bottle which is well stored at a temperature close to 14 degrees Celsius, over a range of approximately 22 degrees, therefore typically between 3 degrees Celsius and 25 degrees Celsius. It should be noted that this is well compatible with the fact that the device 1 covers a wider temperature range comprised between −15 degrees Celsius and +45 degrees Celsius, to store in memory temperature extrema in this wider range.

The position of the temperature mark 39 relative to the groove 37 allows the operator to estimate the current temperature.

To facilitate this estimation, and with reference to FIG. 5, the dial 11 may comprise thermal graduations 100 and 102 around the groove 37. The thermal graduations extend circumferentially around the axis along the groove, first graduations 100 being located between the central axis A and the groove 37, the groove 37 being located between the first graduations 100 and the second graduations 102. The first graduations 100 may correspond to a temperature scale in degrees Celsius. The second graduations 101 may correspond to a temperature scale in degrees Fahrenheit.

The temperature mark 39 is disposed on the upper wall of the gauge 5 and the thermal graduations 100, 102 are disposed on the dial 11 so that the radial direction passing through the central axis and the temperature mark 39 intersects the thermal graduations 100, 102 at a temperature value which is the value of the current temperature.

The temperature mark 39 is advantageously placed equidistant from the two side walls 79 and 81 of the gauge 5. In this way, the gauge 5 is most often visible throughout the groove 37. If, on the contrary, it was chosen to place the temperature mark 39 close to one of the two side walls 79 or 81, then the gauge 5 but also the bimetal strip would be visible through the groove 37, which would be unsightly.

The groove 37 and the slot 27, 29 extend around the central axis A in angular sectors around the axis A which do not overlap. When, in the armed configuration, the needle 7 (respectively 9) is at the same axial height as the side walls 79 or 81 of the gauge 5, then the gauge 5 in rotation can push the needle 7 (respectively 9) in the positive (respectively negative) way. In this situation, a temperature mark 39, placed at an equal distance from the two side walls 79 and 81 of the gauge 5, is intended to occupy an angular sector which does not cover the angular sector of the needle 7 (respectively 9).

### Temperature Extremum Indication

The position of the needle 7 (respectively 9) relative to the dial 11 allows the operator to read the maximum (respectively minimum) temperature experienced by the device 1 since its arming.

To facilitate this reading, and with reference to FIG. 5, the dial 11 may comprise around the slot 27 (respectively 29) a first set 41 of temperature graduations and a second set 43 of temperature graduations. Each set 41, 43 extends circumferentially around the central axis A along the slot 27 (respectively 29). The first set 41 is located between the central axis A and the slot 27 (respectively 29). The slot 27 (respectively 29) is located between the first set 41 and the second set 43. The first set 41 may correspond to a temperature scale in degrees Celsius. The second set 43 may correspond to a temperature scale in degrees Fahrenheit.

When the device 1 is in the armed configuration and the gauge 5 rotates under the effect of a temperature variation such that the needle 7 (respectively 9) is driven by the gauge 5, the needle 7 (respectively 9) is then placed at a certain position in the slot 27 (respectively 29). At a certain extreme temperature, the gauge 5 stops driving the needle 7 (respectively 9) and rotates in the opposite way.

The needle 7 (respectively 9), the first set of graduations 41 and the second set of graduations 43 are configured such that a radial direction defined by the needle 7 (respectively 9) intersects the first set of graduations 41 and the second set of graduations 43 at a temperature value which is the value of the extreme temperature that generated the last motion of the needle 7 (respectively 9).

As mentioned above, the needle 7 (respectively 9) may comprise a first tip 47 and a second tip 49 which both point in the same radial direction. Similarly, the needle 7 (respectively 9) may comprise an internal portion 51 forming a first loop and an external portion 53 forming a second loop. In this situation, the radial direction defined by the needle 7 (respectively 9) can be the radial direction defined by the first tip 47 and the second tip 49. If this radial direction passes through one of the graduations of the first set 41 or of the second set 43, then this graduation can advantageously be surrounded by the first loop of the internal portion 51 or the second loop of the external portion 53. The operator can thus more easily estimate the extreme temperature that generated the last motion of the needle 7 (respectively 9).

Each loop of the internal portion 51 and of the external portion 53 can extend in a radial plane like an arc of a circle over approximately 220° of angle. This allows identifying the extreme temperature value over more than 180 degrees, and limiting the reading error.

The slot 27 (respectively 29) can extend in the circumferential direction over an angle centered on the axis A which corresponds to the angular variation of the bimetal strip during a temperature variation of approximately 20 degrees Celsius. The range can advantageously be comprised between 20 degrees and 25 degrees. If an angle variation is chosen as a function of the temperature variation equal to 2.8 angle degrees per degree Celsius, this gives 56 angle degrees for the extent of the slot 27 (respectively 29) in the circumferential direction. If the device 1 is intended, in operation, to be fixed on a bottle well stored at a temperature close to 14 degrees Celsius, over a range of +22 degrees Celsius, typically therefore between +3 degrees Celsius and +25 degrees Celsius, a slot 27 (respectively 29) may be provided corresponding to a maximum experienced temperature range comprised between +25 degrees and +47 degrees Celsius and/or a minimum experienced temperature range comprised between +5 degrees and −17 degrees Celsius or +3 degrees and −15 degrees Celsius.

When the device 1 comprises the two needles 7 and 9, the dial 11 comprises two slots 27, 29. Advantageously, the groove 37, the first slot 27 and the second slot 29 are evenly distributed angularly around the central axis A. The groove 37 and the two slots 27, 29 may be centered on radial directions which form an angle of 120 degrees in pairs.

### Case

The device 1 may comprise a case 15 defining a housing 16 configured to receive the bimetal strip 3 and the gauge 5. The case 15 extends along the central axis A over a height greater than the sum of the axial height of the bimetal strip and of the axial height of the gauge 5. The case 15 comprises a peripheral wall 22 which extends radially around the central axis A so as to radially surround the bimetal strip 3 and the gauge 5. The case 15 comprises a lower wall 21. The bimetal strip 3 and the gauge 5 are located axially between the lower wall 21 and the dial 11.

The housing 16 is defined by the lower wall 21 and the peripheral wall 22. The housing 16 may be closed by the dial 11. For this purpose, the peripheral wall 22 may define a rim 24 adjusted to the outer diameter of dial 11. The dial 11 can thus be inserted into the case bearing on the rim 24. The dial 11 can be fixed to the case in this position.

The case 15 allows securing the bimetal strip 3 and the gauge 5. Particularly, it becomes more difficult to access the external end of the bimetal strip 67, i.e., the movable and heat-sensitive portion that allows monitoring the temperature of the device 1 over time. The monitoring of this temperature becomes more difficult to falsify. This is even more the case if the dial 11 closes the housing 16 of the case 15.

The lower wall 21 defines an orifice 23 opening out into the housing 16 and the outside of the case 15. The orifice 23 leaves free of material an area passing through the central axis A.

The support 13 comprises a pusher 17 which extends through the lower wall 21 via the orifice 23 along the central axis A.

The pusher 17 extends on the other side of the platform 69 relative to the rods 71 and 73. The pusher 17 extends from the platform 69 along the central axis A. The pusher has a radial length smaller than the radial length of the platform 69.

The pusher 17 and the orifice 23 have shapes complementary in section to the axial direction, i.e. in a radial plane. In this way, the pusher 17 can be inserted into the orifice 23 and slide along the central axis A through the orifice 23. In other words, the support 13 can be moved along the central axis A relative to the case 13, and in doing so change the distance along the central axis A between the bimetal strip 3 and the dial 11.

Since the pusher has a radial length smaller than the radial length of the platform 69, the platform 69 cannot pass through the orifice 23. The platform 69 limits the travel of the pusher 17 along the central axis in a way of displacement, when the platform is in abutment against the lower wall 21. When the platform is in abutment against the lower wall 21, the device is in the neutral configuration of the device.

By acting on the pusher 17, it is possible to switch from the neutral configuration to the armed configuration. More specifically, if the pusher 17 is pressed to move the support 13 towards the dial, the hooks 19 are caused to bear against the inside of the central sleeve 12 of the dial 11. With sufficient force, the support 13 is deformed into its stressed position, the hooks 19 move on the side of the upper face of the dial 11 and the device switches into the armed configuration. In the armed configuration, the pusher 17 extends through the orifice. A mechanical clearance can be ensured so as not to overly constrain the neutral configuration of the device. For this, between a first axial position of the support 13 where the platform is in abutment against the lower wall 21, and a second axial position of the support where the hooks abut against the inside of the central sleeve 12, a distance of less than 0.5 millimeter for example 0.2 millimeter can be provided.

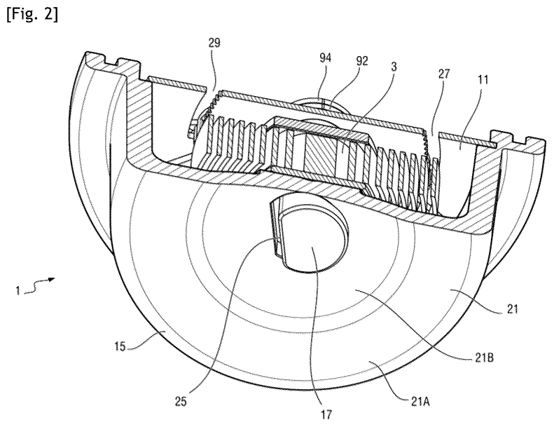

The complementary shapes of the pusher 17 and of the orifice 23 do not have symmetry of revolution relative to the central axis A. For example, and in relation to FIG. 2, this shape is a disk centered on the central axis A, the disk comprising a flat 25 so as not to have symmetry of revolution. In this way, the pusher 17 cannot rotate in the orifice 23 relative to the central axis A. The angular position of the support 13 around the central axis A is fixed relative to the case 15. This means that the internal end 65 of the bimetal strip 3 has an angular position around the central axis A that is fixed relative to the case 15. This means that the external end 67 of the bimetal strip 3 has an angular position around the central axis A that is movable relative to the case 15, this angular position depending solely on the temperature. Since the pusher 17 extends through the orifice in the neutral or armed configuration, the rotation of the pusher 17 relative to the case 15 is blocked in both configurations. In the armed configuration, the pusher 17 does not necessarily protrude outside the case 15. On the other hand, the pusher 17 extends sufficiently through the lower wall 21 facing the orifice 23, so that the pusher is blocked, in the armed configuration, in rotation around the central axis A by the case 15.

The lower wall 21 may comprise:
a peripheral portion 21A which extends orthogonally to the central axis A from the peripheral wall 22 towards the central axis A, and
a central portion 21B which directly surrounds the orifice 23, the central portion 21B being located radially between the peripheral portion and the central axis A.

Advantageously, and in relation to FIGS. 1 and 2, the lower wall 21 has a central recess directed towards the bimetal strip 3 so that the central portion 21B is axially closer to the dial 11 than the peripheral portion 21A.

This recess is large enough so that, in the neutral configuration, the axial end of the pusher 17 is located between the peripheral portion 21A and the dial 11. In other words, in the neutral configuration, one end of the pusher 17 farthest from the bimetal strip 3 is located along the central axis A closer to the bimetal strip 3 than one end of the lower wall 21 farthest from the bimetal strip 3. In other words, and in relation to FIG. 1, by extending the peripheral portion 21A towards the central axis A by a virtual surface 21C orthogonal to the axis A, the pusher 17 and the central portion 21B are located between this virtual surface 21C and the bimetal strip 3.

In the neutral configuration, the pusher 17 may protrude outside the lower wall 21, which implies a risk of unwanted arming when handling the device. The recess allows limiting this risk. In particular, by laying the device on a surface by putting in contact the lower wall 21 on the surface, the recess ensures that the contact only occurs with the peripheral portion 21A. The pusher 17 does not come into contact with the surface.

Optionally, one of the case 15 and of the dial 11 may comprise a notching extending in a circumferential direction to the central axis A and the other of the case and of the dial comprises a tooth configured to collaborate with the notching so as to fix an angular position between the case and the dial. The notching comprises in particular a plurality of notches that are each complementary to the tooth. The tooth can be placed in each of the notches corresponding to a particular angular position of the case 15 relative to the dial 11. It is thus possible to set this angular position before rigidly fixing the dial 11 and the case 15 together. For example, the notching comprises 11 notches, each angularly separated by an angle of 1.4 degrees centered on the central axis A.

This possibility allows adjusting the position of the different thermal graduations comprised by the dial 11 to the bimetal strip 3 and to the gauge 5.

The mounting of the device 1 can begin with the following steps. The bimetal strip 3 is mounted in the support 13 so that the internal end 65 of the bimetal strip is slid into the gap between the two rods 71, 73. The gauge 5 is then mounted on the bimetal strip 3 so that the barrier plates 83, 85 surround the external end 67 of the bimetal strip 3. The support 13 is placed in the case 15 so that the pusher 17 is inserted into the orifice 23 and so that the platform 69 comes into contact with the lower wall 21 of the case 15. The dial 11 is then placed above the gauge 5, so that the rods 71, 73 are inserted into the central sleeve 12. The dial 11 is adjusted so that the current temperature mark 39 of the gauge 5 is visible through the groove 37. The temperature of all of these parts is stabilized at a reference temperature, for example 20 degrees. The angular position of the dial 11 is then adjusted relative to the case 15 by making the position of the current temperature mark 39 coincide with the graduation of the reference temperature. The dial 11 is then fixed to the case 15.

### Transparent Cover Part

The device 1 may advantageously be supplemented by a part 26 made of transparent material facing the dial 11, the dial 11 being enclosed between the case 15 and the transparent material part 26.

The part 26 may take the form of a disk whose center passes through the central axis A. The upper wall of the disk, i.e., the wall opposite to the dial 11, may have an outward curving centered on the central axis A. The part 26 completely covers the dial 11 and advantageously extends beyond it. In other words, the part 26 has a diameter greater than the diameter of the dial 11. Particularly, the part 26 may have a diameter that is equal or almost equal to the external diameter of the case 15. “Almost equal” values here mean values that have a relative deviation of 5% or 2%. The periphery of the part 26 can be used to fix the part to the case 15, in particular by ultrasonic welding.

This welding has non-reversible nature in the sense that once welded, the part 26 and the case 15 can be separated only by destroying at least partly the case 15 and/or the part 26. If this situation occurs, an observer can easily see that the part 26 and the case 15 have been detached from each other.

In relation to this welding step, it may be advantageous to provide that the dial 11, the part 26, the needles 7, 9, the gauge 5 and the support 13 are composed of different materials, and in particular different plastic materials. In this way, the ultrasounds intended to weld the part 26 to the case 15 will not be able to weld the dial 11, the needles 7, 9 and the support 13 to each other or to the part 26 and/or to the case 15. For example, it is possible to chose in particular:
the case 15 made of polycarbonate,
the part 26 made of polycarbonate,
a first needle made of POM, advantageously the needle located between the other needle and the dial,
a second needle made of PA66, advantageously the needle located between the first needle and the part 26,
the dial 11 made of PBT,
the support 13 made of POM, and
the gauge 5 made of PA 66 and 30% fiberglass.

PA66, like the PBT, does not readily weld with the polycarbonate or the POM.

An opaque ring, for example a metal ring, such as anodized aluminum, may be added to cover the area of the part 26 that has been welded. The part 26 may have, facing the dial, a lower wall that follows the relief of the dial, of the needles and of the support 13. Particularly, the lower wall may have a central recess to accommodate the distal ends 20 of the rods 71, 73. The lower wall may be in near contact with the needles 7, 9, i.e. the distance axially separating the lower wall from the needles is less than or equal to 2 millimeters.

The presence of the part 26 makes inaccessible the area of the central sleeve 12 which is in contact with the hooks 19, the needles 7, 9, and more importantly, the bimetal strip 3 and the gauge 5. The part 26 seals the device 1 and ensures its inviolable nature.

The mounting of the device 1 whose first steps were described above, can be continued with the following steps.

The needle 7, 9 or the needles 7, 9 are mounted on the outside of the sleeve 12 above the dial. For each needle, the stopper 55 is inserted through the slot and the needle is placed in a radial plane as close as possible to the gauge 5. This corresponds to the thermal graduations of the slot closest to 15 degrees Celsius. The part 26 made of transparent material is placed against the case 15 so as to cover the dial 11 and the needles 7, 9. The part 26 is welded to the case 15. An opaque annulus is placed at the periphery of the part 26 to mask the weld area.

At the end of the mounting, the device 1 is in a neutral configuration. It is ready to be armed by pressure on the pusher 17.

Once the device 1 is armed, a pad can be placed against the case 15 and the pusher 17 so as to seal the position of the pusher 17.

Optionally, the arming can be performed when the device 1 is affixed in an object, for example a bottle. The device 1 is inserted into a housing provided in the object so that the dial is visible from the outside. The housing comprises a bearing configured to be placed facing the pusher 17. The housing has edges against which the case is fixed, these edges being in contact with the case only after the bearing comes into contact with the pusher 17 and moves the pusher 17 towards the dial 11 so as to arm the device. The case then comes into contact with the edges and can be fixed to the object. In this option, the fixing of the device to the object and its arming are simultaneous.

### Method for Indicating the Temperature Extremum

The device 1 as it has been presented up to now allows implementing a method for indicating the temperature extremum comprising the non-reversible switching:
from a neutral configuration where the needle 7, 9 remains stationary when the gauge 5 is driven in rotation by the bimetal strip 3,
to an armed configuration where the needle 7, 9 is driven in rotation by the gauge.

The needle 7, 9 may be mounted on the dial 11 such that the needle 7, 9 is movable relative to the dial 11 around the axis A. In this case, the switching from the neutral configuration to the armed configuration comprises the displacement along the central axis A of the support 13 of the bimetal strip 3 towards the dial 11 and the attachment of the hooks 19 to the dial 11 by elastic deformation.

The displacement may be configured in particular such that the distance along an axial direction parallel to the axis between the gauge 5 and the lower face 33 of the dial 11, the lower face 33 facing the bimetal strip 3 becomes smaller than or equal to a distance along the axial direction between a stopper 55 of the needle 7, 9, and the lower face 33, the stopper 55 being located between the dial 11 and the bimetal strip 3.

1. A device for indicating the temperature extremum, the device comprising:
a bimetal strip,
a gauge configured to be driven in rotation by the bimetal strip, and
a needle,
the device being configurable in a neutral configuration or in a armed configuration,
the needle remaining stationary when the gauge is driven in rotation by the bimetal strip if the device is in the neutral configuration.
the gauge driving the needle in rotation when the gauge is driven in rotation by the bimetal strip if the device is in the armed configuration,
the device being configured to switch in a non-reversible manner from the neutral configuration to the armed configuration.

2. The device according to claim 1 comprising:
a dial, the needle being movably mounted on the dial in rotation around an axis, and
a support for the bimetal strip, the support comprising hooks, so that when the device switches from the neutral configuration to the armed configuration, the support moves along the axis towards the dial and the hooks deform elastically to attach to the dial.

3. The device according to claim 2 wherein the dial comprises a disk extending all around the axis and comprising an upper face and a lower face, the lower face facing the bimetal strip, the disk having a slot which extends in a circumferential direction around the axis, the slot passing through the dial from the upper face to the lower face along an axial direction parallel to the axis, the needle comprising a main body and a stopper, the dial being located between the bimetal strip and the main body of the needle, the needle extending passing through the slot of the dial in the axial direction, the stopper protruding from the dial from the lower face, the stopper being located along the axial direction between the dial and the bimetal strip, the device being configured:
so that, in neutral configuration, the stopper and the gauge are separated along the axial direction so that the stopper is located along the axial direction between the lower face and the gauge, and
to switch from the neutral configuration to the armed configuration by displacement of the support, of the bimetal strip and of the gauge towards the dial along the axial direction so that along the axial direction, a distance separating the lower face and the gauge is smaller than or equal to a distance separating the lower face and the stopper.

4. The device according to claim 3, wherein the needle, is movably mounted on the dial in a single way of rotation around an axis

5. The device according to claim 3 wherein the dial defines a groove passing through the dial from the upper face to the lower face along the axial direction, the groove extending in a circumferential direction around the axis, so that the gauge facing the groove along the axial direction, the groove and the slot extending around the axis in angular sectors around the axis which do not overlap, the groove extending around the axis in a first angular sector and the slot extending around the axis in a second angular sector, the first angular sector and the second angular sector being separated.

6. The device according to claim 3 wherein the upper face comprises a first set of temperature graduations and a second set of temperature graduations, each set extending circumferentially around the axis along the slot the first set being located between the axis and the slot, the slot being located between the first set and the second set, the needle comprising:
a circumferential portion which extends circumferentially facing the slot, the circumferential portion comprising a first tip in the direction of the first set and a second tip in the direction of the second set, the first tip and the second tip defining a same radial direction relative to the axis,
an internal portion which extends facing the first set of graduations and forms a first loop,
an external portion which extends facing the second set of graduations and forms a second loop,
the upper face and the needle being configured so that when the radial direction defined by the first tip and the second tip the passes through one of the graduations, the one of the graduations is surrounded by the first loop or the second loop.

7. The device according to claim 1, wherein the needle is a first needle, the device comprising a second needle, the first needle and the second needle being configured to be driven by the gauge in different ways of rotation.

8. The device according to claim 7 in its dependency on claim 5, wherein the slot is a first slot, the dial having a second slot which extends in a circumferential direction around the axis, the groove, the first slot and the second slot being evenly distributed angularly around the axis.

9. The device according to claim 2, comprising a case defining a housing closed by the dial, the bimetal strip and the gauge being located in the housing, the case comprising a lower wall, the bimetal strip being located axially between the dial and the lower wall, the lower wall defining an orifice opening out into the housing and outside the case, the support comprising a pusher which extends through the lower wall through the orifice along the axis, the pusher and the orifice having shapes complementary in section to the axial direction, the complementary shapes not having symmetry of revolution relative to the axis.

10. The device according to claim 9, wherein the lower wall has a central recess directed towards the bimetal strip so that, in the neutral configuration, one end of the pusher farthest from the bimetal strip is located along the central axis closer to the bimetal strip than one end of the lower wall farthest from the bimetal strip.

11. The device according to claim 9, wherein one of the case and of the dial comprises a notching extending in a circumferential direction to the axis and the other of the case and of the dial comprises a tooth configured to collaborate with the notching so as to fix an angular position between the case and the dial.

12. The device according to claim 9, comprising a part made of transparent material facing the dial, the dial being enclosed between the case and the transparent material part.

13. A method for indicating a temperature extremum comprising a non-reversible switching:
from a neutral configuration where a needle remains stationary when a gauge is driven in rotation by a bimetal strip,
to an armed configuration where the needle is driven in rotation by the gauge when the gauge is driven in rotation by the bimetal strip.

14. The method according to claim 13, wherein the needle is mounted on a dial so that the needle is movable relative to the dial around an axis, the switching from the neutral configuration to the armed configuration comprising the displacement along the axis of a support of the bimetal strip towards the dial and the attachment of hooks of the support to the dial by elastic deformation of the hooks.

15. The method according to claim 14 wherein the displacement of the support is configured so that a distance along an axial direction parallel to the axis between the gauge and a lower face of the dial, the lower face facing the bimetal strip, becomes smaller than or equal to a distance along the axial direction between a stopper of the needle and the lower face, the stopper being located between the dial and the bimetal strip.

16. The device according to claim 4, wherein the needle comprises a pawl, the slot and the pawl being in contact according to asymmetrical toothed shapes.

17. The device according to claim 8, wherein the second needle comprises a second pawl, the second slot and the second pawl being in contact according to asymmetrical toothed shapes.
